(19) United States
(12) Patent Application Publication
(10) Pub. No.: US 2008/0116084 A1
(43) Pub. Date: May 22, 2008

(54) Painter's palette

(76) Inventor: Linda L. Nelson, Arden Hills, MN (US)

Correspondence Address: Curtis D. Kinghorn;Sirius Strategic, LLC, 6769 W. Shadow Lake Dr., Lino Lakes, MN, 55014, US

(21) Appl. No.: 11/604,132

(22) Filed: Nov. 22, 2006

(51) Int. Cl. B44D 3/02

(52) U.S. Cl. 206/1.7

(57) ABSTRACT

A painter's palette is disclosed having a mixing area large enough to support the artist's color mixing needs with recessed paint troughs formed or attached to either side of the mixing area to store the various daubs of artist paint, separate the daubs from the main mixing surface, facilitate clean up of the mixing area, minimize the surface area of paint exposed to air, protect the user's sleeves and hands from paint daub contact, add structural integrity to the palette and support the palette at a reasonable distance above a flat surface to facilitate handling of the palette. Trough end caps or closed trough ends facilitate submerging paint daubs in the troughs in water. A centralized opening for the thumb or finger makes left and right hand use possible. The palette preferably has a medium color value or is white to allow the user to judge and facilitate the mixing of paint colors. The palette preferably includes a grayscale value segment and a color wheel reference guide to help the artist ascertain and determine color relationships. The palette is also preferably part of a system including a storage and transportation case that also allows the case, including the palette, to be stored in a refrigerator or freezer.

### BACKGROUND OF THE INVENTION

1. Field of the Invention

This invention relates to painter's palettes of the type held in the artist's hand and resting on the artist's arm.

2. Description of Related Art

Most hobby artists start their exploration of the arts by purchasing art materials that are readily available in retail stores. Many of these products are not sophisticated, and they are intended to be sold to the uneducated or neophyte consumer and are not fully functional to support a maturing artist. As Artists use these products, they may or may not realize the non-functionality of these products, and usually continue buying additional materials in an unfortunate attempt to meet their painting needs in a cycle of trial and error. Many times artists resort to making their own devices to accommodate their blooming needs since commercial products are not available to suit the needs of the artist as they develop their own knowledge and techniques.

This scenario is certainly true when it comes to painter's palettes and their method of use. Some of the problems encountered are: How does a painters' palette affect my work? How do I effectively mix and store my paints, and prevent my oil paint from drying out, once deposited on the palette? What is the most prudent way to keep a painter's palette clean from the residue of oil paint? Does the surface color of the palette impact my work? Is the position of the palette in left hand, right hand or on the table important? How do I judge the colors I am looking at and the colors I am mixing and how does the palette influence that judgment?

Devices to solve some of these past problems are known such as those shown in U.S. Pat. No. 4,765,457 entitled “Paint Box” issued to Claus Rayhle on Aug. 23, 1988; U.S. Pat. No. 4,740,014 entitled “Palette with Disposable Mixing Surface for Mixing Blendable Materials” issued to George G. Holt on Apr. 26, 1988; and U.S. Pat. No. 5,277,302 entitled “Combination Paint Palette and Storage Device” issued to Jon S. Seisa on Jan. 11, 1994. These devices do not fully resolve the broad aspect of problems encountered in artistic training and the use of an adequate painter's palette.

From the above, it can be seen what is needed is a painter's palette that is easily cleanable, keeps the paint from drying out and that has a grayscale value scale and color wheel on a neutral surface. In addition, it is desirable to have such a palette that is easily stored in its own storage box.

### SUMMARY OF THE INVENTION

A painter's palette is disclosed having a mixing area large enough to support the artist's color mixing needs. Recessed paint troughs are formed or attached to either side of the mixing area to store the various daubs of artist paint. These troughs separate the daubs from the main mixing surface and their recessed nature facilitates easy clean up of the mixing area. Because the troughs are recessed, the depth of troughs minimizes the surface area of paint exposed to air and protects the user's sleeves and hands from paint daub contact. The troughs also add structural integrity to the palette as well as adding the functional feature of supporting the palette at a reasonable distance above a table top to facilitate handling of the palette. The palette surface preferably has a medium color value to allow the user to judge and facilitate the mixing of paint colors A centralized opening for the thumb or finger makes left and right hand use possible.

In a preferred embodiment of the palette, the palette includes a grayscale value segment and a color wheel reference guide to help the artist ascertain and determine color relationships.

In a preferred embodiment, the palette is part of a system including a storage and transportation container that also acts as a carrying case. The storage and transportation container is preferably large enough to allow for storage of other art materials and supplies in addition to storing the palette. The storage and transportation container is engineered to allow the user to transport the palette parallel to the ground, allowing “wet” paint to remain on the palette. This allows the user to retain whatever investment of paint the user has on the palette between transports. To this same end, the storage and transportation container is engineered with enough open space between the palette's top surface and the underside of the lid of the storage and transportation container to allow reasonable paint daubs to not contact the lid during storage and transport.

In a most preferred embodiment, the storage and transportation container is storable in a refrigerator or freezer to prevent the oil paints, deposited from tubes onto the mixing area or into the troughs, from drying out. To this same end, the palette troughs possess end caps and the palette surface is water repellant so that the user may fill the troughs with water (for example, by submerging the palette and daubs on the palette and in the troughs in water) thereby effectively inhibiting the dry time of the daubs.

It is therefore an object of the present invention in one or more embodiments to provide a painter's palette that has:

a mixing area large enough to support the artist's color mixing needs;

recessed paint troughs formed with or attached to either side of a mixing area to store the various daubs of artist paint;

recessed paint troughs formed with or attached to either side of a mixing area to separate paint daubs from the main mixing surface of the palette;

recessed paint troughs formed with or attached to either side of a mixing area that facilitates easy clean up of the mixing area;

recessed paint troughs formed with or attached to either side of a mixing area that minimizes the surface area of paint exposed to air;

recessed paint troughs formed with or attached to either side of a mixing area that protects the user's sleeves and hands from paint daub contact;

recessed paint troughs formed with or attached to either side of a mixing area that also add structural integrity to the palette;

recessed paint troughs with end caps to facilitate the submerging of the paint daubs in water, thus inhibiting their drying out between uses;

recessed paint troughs formed with or attached to either side of a mixing area that supports the palette at a reasonable distance above a table top or other flat surface to facilitate handling of the palette;

a medium color value, including, but not limited to, a mixture of cool and warm colored grays, to allow the acrylic or oil paint user to judge and facilitate the mixing of the acrylic or oil paint colors;

a centralized opening for the thumb or finger that makes left or right hand use or both left and right hand use possible;

a grayscale value segment; and

a color wheel reference guide.

It is therefore also an object of the present invention in one or more embodiments to provide a painter's palette that is:

a part of a system including a storage and transportation container that is large enough to allow for storage of other art materials and supplies in addition to storing the palette;

part of a system including a storage and transportation container that is storable in a refrigerator or freezer to inhibit oil paints, deposited from tubes onto the mixing area or into the troughs of a palette according to the teachings of this invention, from drying out;

part of a system including a storage and transportation container that is capable of being stored in a refrigerator or freezer to keep oil paints, deposited from tubes onto the mixing area or into the troughs, from drying out, and engineered to allow parallel-to-the-ground transport and a clear space above the palette to accommodate the transport or storage of a palette “loaded” with paint daubs.

Not all of these objects need be present in a single embodiment. Instead, a particular embodiment may have one or more of these objects. These and other objects of the invention will be clear from the following detailed description of the invention in connection with the drawings

### BRIEF DESCRIPTION OF THE DRAWINGS

The invention will be described hereafter in detail with particular reference to the drawings. Throughout this description, like elements, in whatever embodiment described, refer to common elements wherever referred to and referenced by the same reference number. The characteristics, attributes, functions, interrelations ascribed to a particular element in one location apply to that element when referred to by the same reference number in another location unless specifically stated otherwise. In addition, the exact dimensions and dimensional proportions to conform to specific force, weight, strength and similar requirements will be within the skill of the art after the following description has been read and understood. Furthermore, when the terms “top”, “bottom”, “side” and similar terms are used herein, it should be understood that these terms have reference only to the structure shown in the drawings as it would appear to a person viewing the drawings and are utilized only to facilitate describing the embodiments.

All Figures are drawn for ease of explanation of the basic teachings of the present invention only; the extensions of the Figures with respect to number, position, relationship, and dimensions of the parts to form examples of the various embodiments will be explained or will be within the skill of the art after the following description has been read and understood. Further, the exact dimensions and dimensional proportions to conform to specific force, weight, strength and similar requirements will likewise be within the skill of the art after the following description has been read and understood.

FIG. 1 is a perspective view of one embodiment of the painter's palette of the present invention.

FIG. 2 is a plan view of the painter's palette of FIG. 1.

FIG. 3 is an end view of the painter's palette of FIG. 1.

FIG. 4 is an end view of a variant of the painter's palette of FIG. 1.

FIG. 5 is a perspective view of the painter's palette of FIG. 1 in a storage box with the storage box's cover open.

FIG. 6 is a side sectional view of painter's palette of FIG. 4 in the storage box of FIG. 5 with the storage box's cover closed.

FIG. 7 is a perspective view of the painter's palette of FIG. 1 in use.

FIG. 8 is a front view of the painter's palette of FIG. 4 in storage in a freezer with the freezer's door open.

FIG. 9 is a perspective view of an alternate embodiment of the painter's palette of the present invention.

FIG. 10 is a perspective view of an embodiment of the painter's palette of the present invention using trough end caps.

### DETAILED DESCRIPTION OF THE INVENTION

In order that the invention may be clearly understood and readily carried into effect, preferred embodiments of the invention will now be described, by way of example only and not to limit the invention, with reference to the accompanying drawings. The palette of the present invention is shown in the drawings generally labeled 10. The palette includes a mixing surface 12 having a top side 14 and a bottom side 16. In the preferred embodiment of the palette 10, the mixing surface 12 has a gripping hole 18 that extends entirely through the mixing surface 12. Also in the preferred embodiment, the mixing surface 12 is rectangular with opposed sides 20 and opposed ends 22. The preferred embodiment of the palette 10 includes two troughs 24 formed along the opposed sides 20.

In the preferred embodiment of the palette 10, the mixing surface 12 is generally planar. As mentioned, the mixing surface 12 is preferably rectangular but may also have any quadrilateral form or any other shape including, but not limited to, triangular, pentagonal, hexagonal, septagonal, octagonal, nonagonal, decagonal, n-sided polygon, elliptical, oval, circular, parallelogram, rhombus, square, trapezoid, the shape of known objects of forms (e.g., trademarks), geographic areas (e.g., the shape of states or countries) or free-form. Further, although the mixing surface 12 is preferably planar, the mixing surface 12 may also be nonplanar.

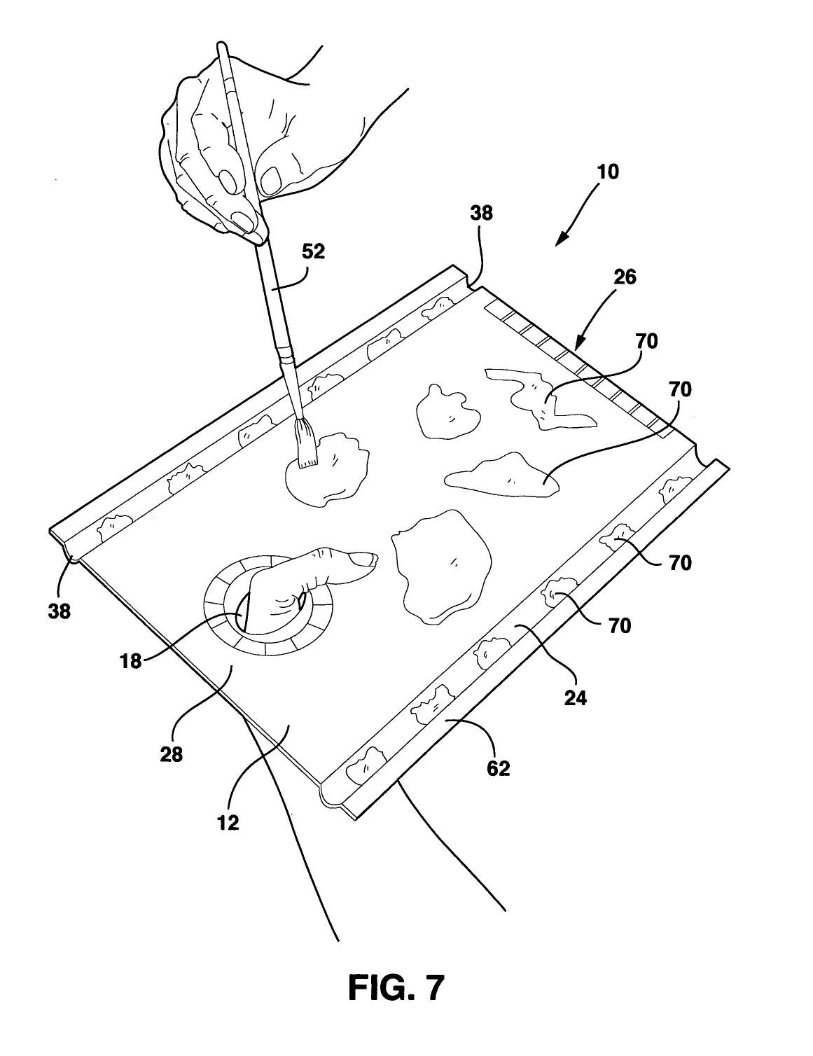

As mentioned, the palette 10 preferably includes a gripping hole 18 located within the boundaries of the mixing surface 12. This gripping hole 18 is preferably located near one opposed end 22 of the mixing surface 12 and is more preferably located near one opposed end 22 of the mixing surface 12 and equally located between the opposed sides 20. In this way, either left-handed or right-handed users of the palette 10 are able to grip the palette 10 with equal functionality by inserting a thumb or finger through the gripping hole 18 as is commonly done with such palettes in use (FIG. 7).

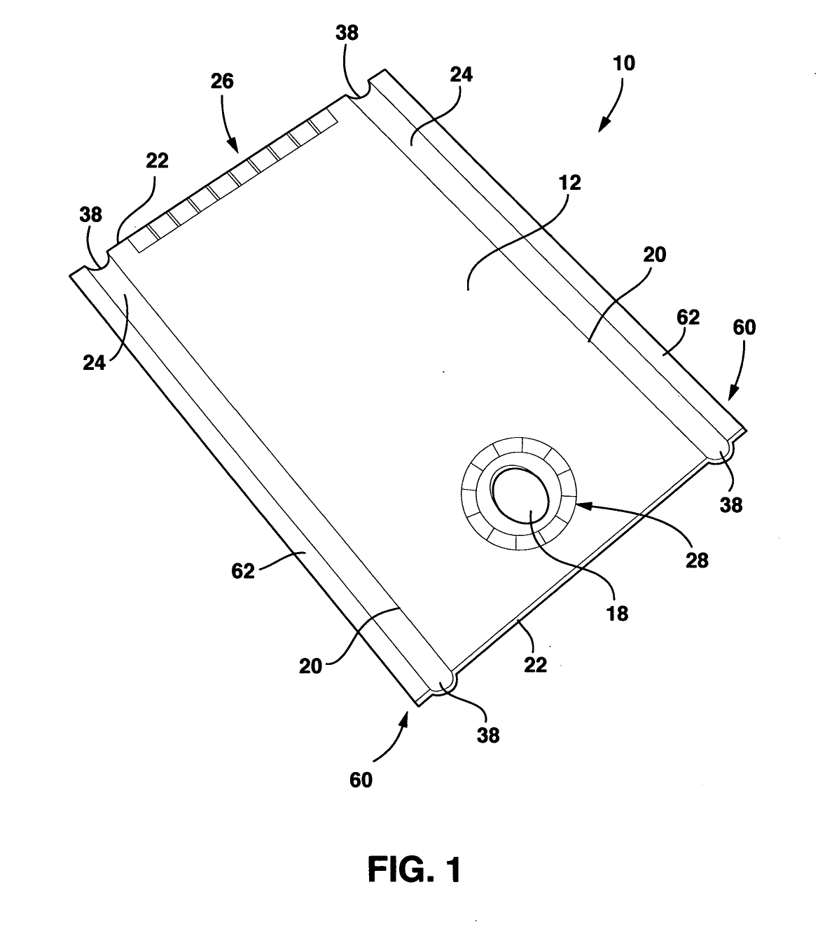

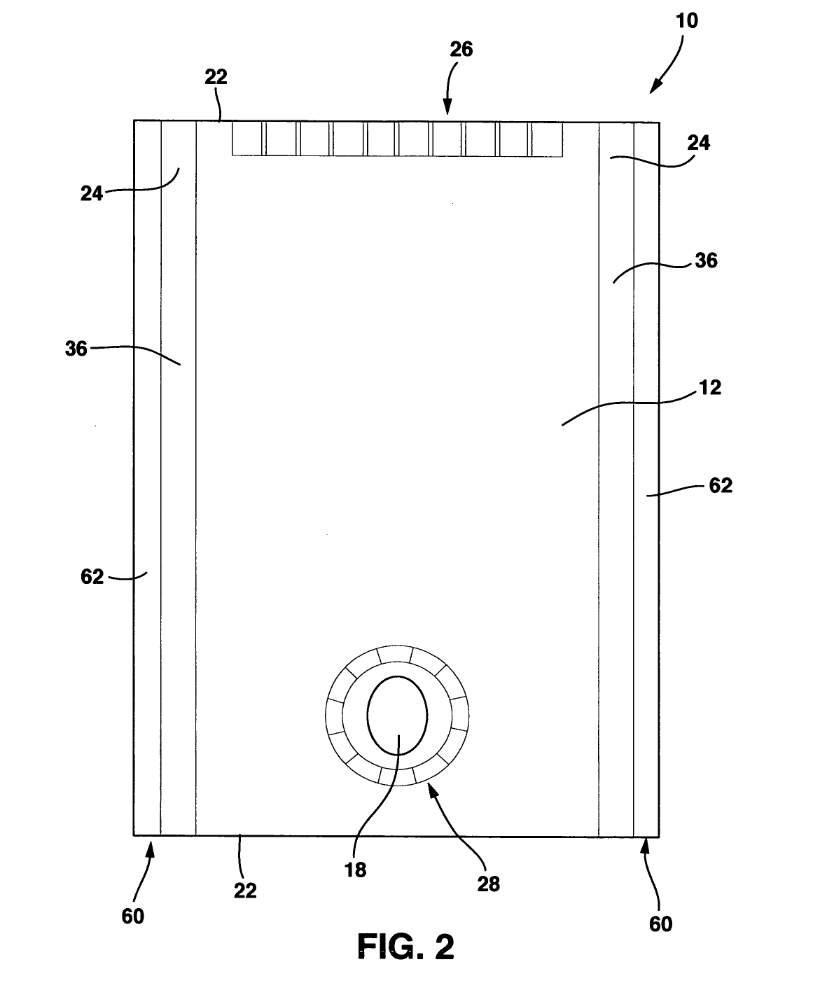

In the preferred embodiment of the palette 10 (FIGS. 1 and 2), at least one grayscale segment 26 is located on the mixing surface 12 preferably near or at one opposed end 22. This grayscale segment 26 is a value chart that allows the painter to ascertain the value of color of the paint they are creating by mixing paint on the mixing surface 12 by comparing the relative value of such paint to the values depicted on the grayscale segment 26. This arrangement of the grayscale segment 26 makes possible holding the palette 10 up to a subject to make comparison of subject value and value scale. Making this value determination is particularly valuable since value is the most important component in color. This allows color mixing to be engineered and value arrangements facilitated by use of this systematic combination of elements.

Although the preferred embodiment of the palette 10 has one grayscale segment 26 located on the mixing surface 12 near or at one opposed end 22 of the palette 10, the grayscale segment 26 may be located anywhere on the mixing surface 12. In addition, more than one grayscale segment 26 may be used and located as desired on the mixing surface 12.

Also in the preferred embodiment of the palette 10 (FIGS. 1 and 2), at least one color wheel 28 is located on the mixing surface 12 preferably near or at one opposed end 22 and more preferably around the gripping hole 18. This color wheel 28 is any well known and understood color wheel in any variant including, but not limited to, traditional and painters' color wheels (“R.O.Y.G.B.I.V.”) that display primary, secondary and tertiary colors and may include hues, neutral values and intensities of these colors. The color wheel 28 allows the painter to ascertain color harmonies and schemes of color of the paint they intend to use or are creating by mixing paint on the mixing surface 12. Although the preferred embodiment of the palette 10 has one color wheel 28 located on the mixing surface 12 near or at one opposed end 22 of the palette 10, preferably around the gripping hole 18, the color wheel 28 may be located anywhere on the mixing surface 12. In addition, more than one color wheel 28 may be used and located as desired on the mixing surface 12.

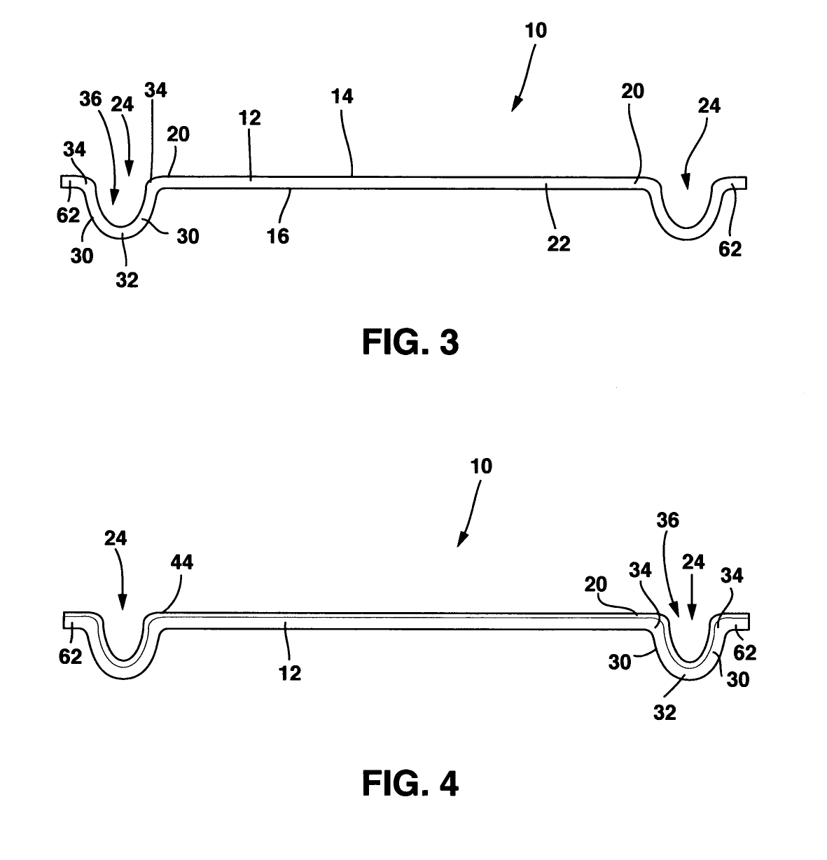

As described above, the palette 10 preferably includes two troughs 24 formed along the opposed side 20 of the mixing surface 12. As can be seen in FIGS. 3 and 4, troughs 24 have a concave cross-section with sides 30, a bottom portion 32 at the lowest portion of sides 30 where the sides 30 come together and an upper portion 34 between open ends of the sides 30 forming an opening 36 between the upper ends of the sides. In this configuration, the bottom portion 32 of troughs 24 is lower than the upper portions 34 of the troughs 24. Troughs 24 are integrally formed with or attached to the mixing surface 12 so that the troughs 24 extend downward lower than the bottom side 16 of the mixing surface 12. As a result, when the palette 10 is placed on a tabletop or other flat surface, the mixing surface 12 is located a distance above the surface of the tabletop or other flat surface. This allows the user to more easily grip and lift the palette 10 by placing his or her hand in the area between the tabletop or other flat surface and the bottom side 16 of the mixing surface 12.

Although the preferred embodiment of appellate 10 includes two troughs 24, a single trough 24 may be formed along a single opposed side 20. In another embodiment of the palette 10, a trough 24 may be formed on every side of the mixing surface 12 or on three of the four sides of the mixing surface 12 where the mixing surface 12 has a quadrilateral form or one or more troughs 24 may be attached to any side of the mixing surface 12 as desired.

The function of the troughs 24 is to hold paint that the user intends to use and, in some embodiments, to add structural integrity to the palette 10. Because these troughs 24 are recessed (i.e., the bottom portion 32 is lower than the upper portions 34), paint placed in the troughs 24 is exposed to the air primarily at opening 36 so that the paint has less surface area exposed to the air than if the pain were left on the mixing surface 12. As a result, the troughs 24 promote the paint kept in the troughs 24 from drying out as fast as they would if they were placed on a flat surface.

An additional benefit of placing paint in the troughs 24 is that because the paint is lower than would be if it were placed on the mixing surface 12, placing paint in the troughs 24 reduces the risk of the painter's hand inadvertently contacting the paint as often as would occur where the paint located at the same level as or on the mixing surface 12.

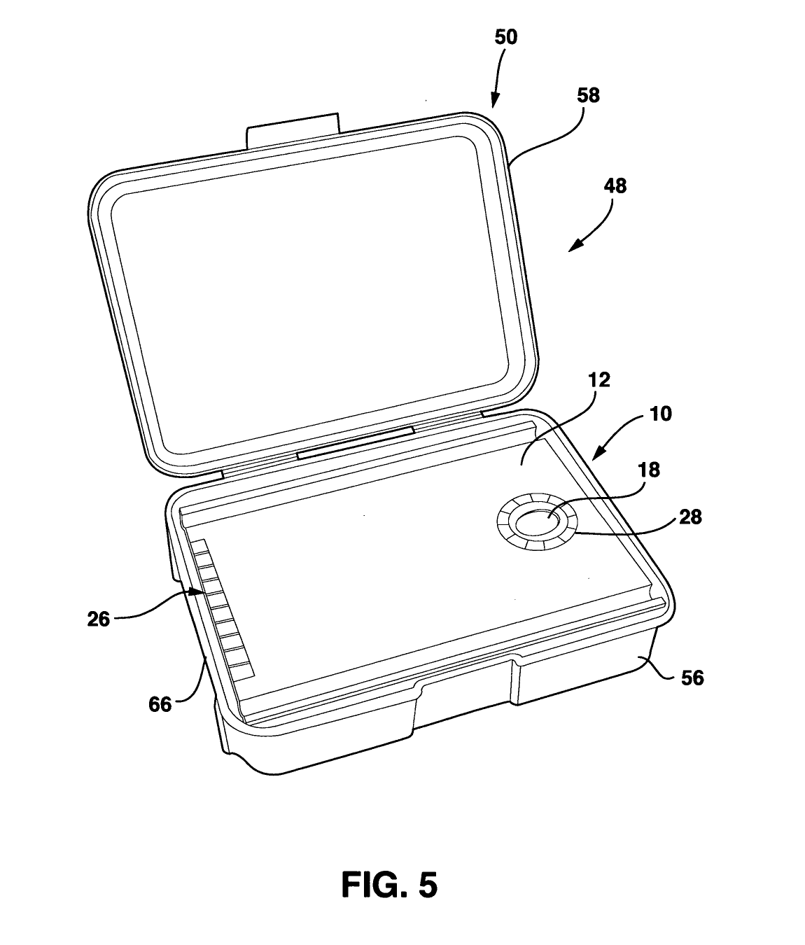

In the preferred embodiment shown in FIGS. 1-8, the troughs 24 have open ends 38. In an alternate embodiment of the palette 10 shown in FIG. 9, the ends 38 of the troughs 24 have end caps 40 that are dimensioned to fit securely into or onto the ends 38 of the troughs 24 by means well understood in the art including, but not limited to, friction fit, mechanical connection, snaps, adhesives, screws or clamps. These end caps 40 may be either permanently attached to the ends 38 of the troughs or removable as desired. The end caps 40 prevent the paint from moving out of the troughs 24 and minimize the surface area of paint placed against the end caps 40 that is exposed to air thereby slowing the drying of these paints. In addition, the end caps 40 allow water to be retained in the troughs 24 which minimizes the exposure of paint contained in the troughs to air when the troughs are filled with water thereby inhibiting the drying of these paints.

In another alternate embodiment of the palette 10, the troughs 24 have integrally formed closed ends 42 at the ends 38 of the troughs 24. These integrally formed closed ends 42 also prevent the paint from moving out of the troughs 24 and minimize the surface area of paint placed against the closed ends 42 that is exposed to air thereby slowing the drying of these paints. Further, the closed ends 42 also allow water to be retained in the troughs 24 which minimizes the exposure of paint contained in the troughs to air when the troughs are filled with water thereby inhibiting the drying of these paints. These closed ends 42 are preferably integrally formed with the palette 10 as the palette 10 is formed as described above.

The palette 10 is preferably sized and shaped to small enough to be portable with art books and other items that the painter may carry with him or her. In the preferred embodiment of the palette 10, the palette 10 is made of plastic, wood, glass, cardboard, paper, metal, ceramic, or any other sturdy inert material preferably by molding, pressing, punching, shaping and then setting the shape as, for example, by firing or other techniques well understood in the art for integrally forming such devices. It may also be desirable to make the palette 10 out of biodegradable or recycled material and may be engineered to be disposable or otherwise easily cleanable for reuse. Of course, the fact that the palette 10 in one embodiment is disposable greatly aids the user in clean up from painting activities since the palette 10 is simply disposed of rather than cleaned.

In this preferred embodiment of the palette 10, the mixing surface 12 and troughs 24 are integrally formed of the same material at the same time. It is also desirable, but not required, that the palette 10 be made so that several palettes 10 may be stacked or nested on top of each other to facilitate storage and transport of the palette 10. Although the preferred embodiment of the palette 10 has the troughs 24 integrally formed with the mixing surface 12, the troughs 24 may be formed independently of the same or dissimilar materials as the mixing surface 12 and attached to the mixing surface 12 by means well-known it in the art including, but not limited to, adhesives, screws, clamps, snaps, friction fit or mechanical connection.

In one embodiment of the palette 10, contact paper 44 overlies the palette 10. This contact paper 44 is preferably dimensioned to correspond to the dimensions of the palette 10 so that the contact paper 44 covers the entire upper surface of the palette 10 including lining the troughs 24 (FIG. 4). Although the preferred embodiment of the invention palette 10 has the contact paper 44 covering the entire upper surface of the palette 10 including the top side 14 of the mixing surface 12 and lining the troughs 24, it is also within the scope of the invention to have the contact paper 44 covering only the top side 14 of the mixing surface 12, portions of the top side 14 of the mixing surface 12 or lining only a portion of the troughs 24 or lining less than all of the troughs 24.

The contact paper 44 is preferably a thin, flexible material like contact paper (sometimes referred to as “shelf paper”) that is sticky on one side only which sticky side contacts the upper surface of the palette 10 at the top side 14 of the mixing surface 12 and lines the troughs 24 in all the variants described above. In a variant of the contact paper 44, only the peripheral edges 46 of the contact paper 44 are sticky on one side of the contact paper 44. Also, contact paper 44 is preferably clear so that the user can see the grayscale segment 26 or color wheel 28 on the mixing surface 12. However, the contact paper 44 may also itself be colored or included a grayscale segment 26 or color wheel 28 or both as described above.

In use, the contact paper 44 is applied to the upper surface of the palette 10 on the top side 14 of the mixing surface 12 and in the troughs 24 before painting to protect the palette 10. After the painting is done, the contact paper 44 is removed from contact with the palette 10 and thrown away. The next time it is desired to do painting, a new contact paper 44 is applied to the palette 10.

In a variant of this embodiment, several pieces of contact paper 44 are stacked upon each other in layers and placed in contact with the upper surface of the palette 10 in contact with the tops side 13 of the mixing surface 12 and lining the troughs 24. In use, the painter places the paint to be mixed or applied on the contact paper 44 above the mixing surface 12 or in the troughs 24. When the painter is done painting, the top layer of contact paper 44 along with the paint applied to the contact paper 44 is removed and disposed of. As a result, a new, clean piece of contact paper 44 is present for the painter for use.

In a variant of the contact paper 44, the contact paper 44 may be made of layers of water absorbable material like watercolor paper and a cover layer of plastic or similar material that is somewhat porous to water. In this embodiment, the contact paper 44 is applied to the palette 10 as described above. However, before use, the contact paper 44 is wet with clean water so that the water absorbent layer of the contact paper 44 absorbs the water. Then, as the painter places acrylic paint on cover layer of the contact paper 44, as the water in the acrylic paint evaporates, the water is replaced by water held in the absorbable layer of that contact paper 44 that passes from the absorbable layer through the cover layer to the paint through osmosis so the paint doesn't dry out as fast as normal.

In the preferred embodiment of the palette 10 for use by users of acrylic or oil paints, the entire palette 10 including the troughs 24 but excluding the grayscale color segment 20 and color wheel 28 is made of a material or is otherwise colored to have a medium value or neutral color. This medium value or neutral color is preferably a marbled combination of cool and warm gray. By having the palette 10 in a medium value or neutral color, the painter is able to mix colors without being influenced by visual interactions between the color they are creating and the palette 10 itself.

In the preferred embodiment of the palette 10 for use by users of watercolors, the entire palette 10 including the troughs 24 but excluding the grayscale color segment 20 and color wheel 28 is made of a material or is otherwise colored white. Having the palette 10 in this white color provides a more appropriate reference to judge the watercolor paint colors and the color resulting from the mixing of these watercolor paints.

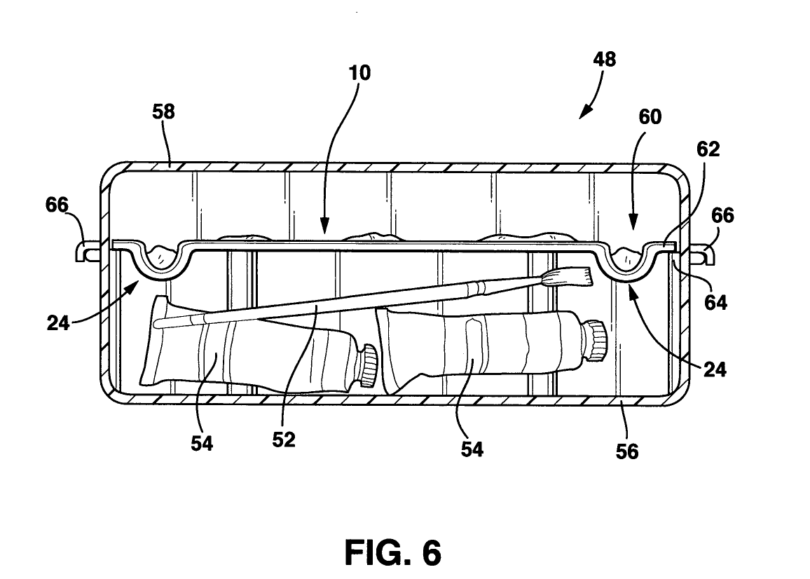

In a preferred embodiment of the invention, the palette 10 is part of a system 48 that includes a box 50 (FIG. 6) for storing the palette 10. The function of the box 50 is to store the palette 10 along with the paint brushes 52, paints 54 and other instruments commonly used by painters. The box 50 includes a bottom portion 56 and a top portion 58. In this embodiment, the outer edge 60 of the palette 10 includes a lip 62 that extends away from the main body of the palette 10. The bottom portion 56 has a ledge 64 on its inside surface that is dimensioned to hold the lip 62 so that the palette 10 is supported by the interaction of the lip 62 and the ledge 64 in the bottom portion 56.

The bottom portion 56 is preferably sized to allow paint brushes 52 and paint 54 to be stored within the bottom portion 56. This allows the palette 10, paint brushes 52 and paints 54 along with all other instruments used by the painter to be conveniently and efficiently carried to locations of interest to the painter.

The top portion 58 is preferably sized to mate with the bottom portion 56 to form an integral box 50. In the preferred embodiment of the box 50, the top portion 58 is sized to allow a space between any paint on the mixing surface 12 of the palette 10 and the top portion 58. This allows the user to store and transport the palette 10 “loaded” with daubs of paint on the mixing surface 12 or in the troughs 24 without contact with the top portion 58. The box 50 also preferably has handles 66 to allow the box 50 to be more easily grasped and transported.

In a more preferred embodiment of the invention, the box 50 allows the palette 10, paint brushes 52, paints 54 and other instruments to be stored in a freezer or refrigerator. The advantage of storing the palette 10, paint brushes 52, paints 54 and other instruments in a cool environment such as that produced by a freezer or refrigerator is that when oil-based paints are stored in cold or cool places, they don't dry out as fast as they would in warmer environments. As result, a painter with an oil-based paint on the palette 10 could place the palette 10 in the box 50 and then place the box 50 in the refrigerator or freezer. After a period of time, the painter could retrieve the box 50 with the palette 10 containing the paint and resume painting without having the paint rendered useless by drying out.

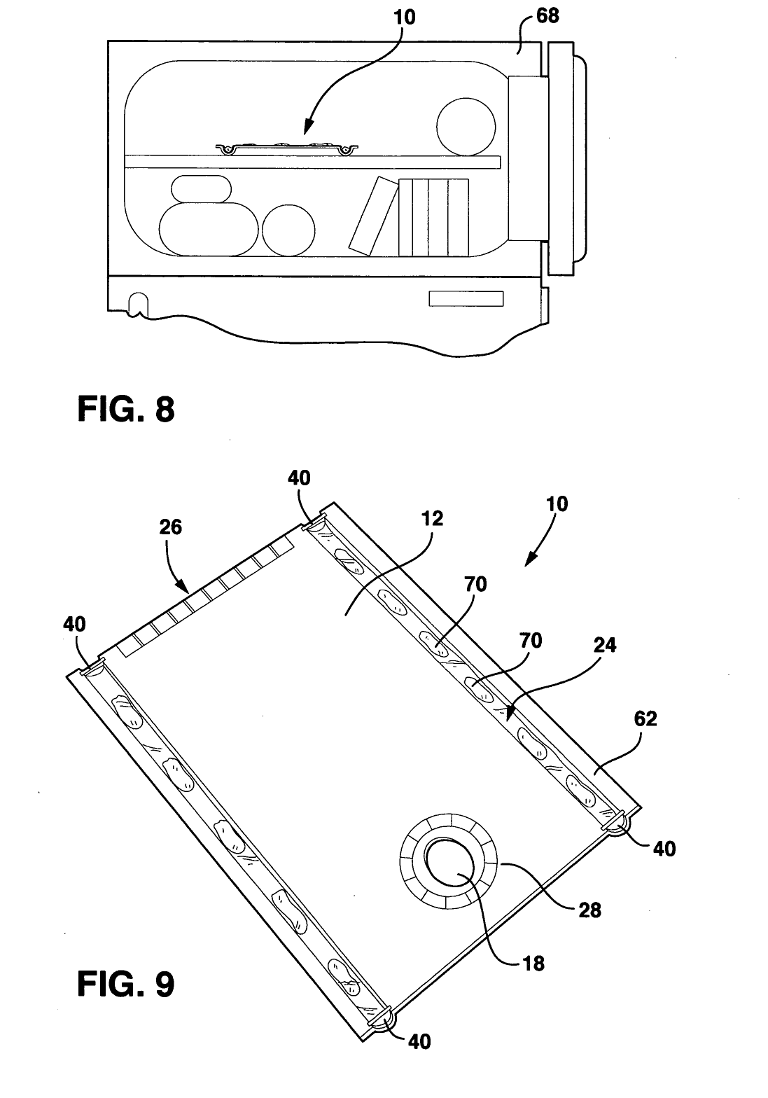

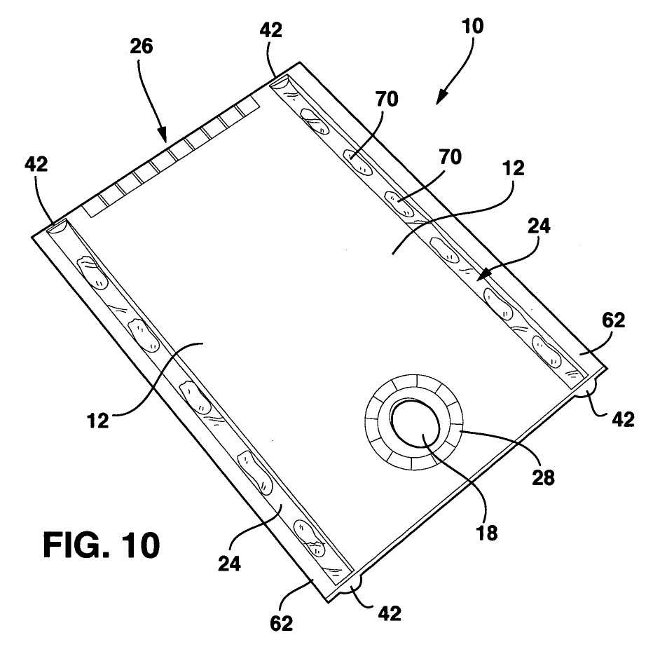

Although it is desirable to have a box 50 to store the palette 10 particularly where the palette 10 along with paint brushes 52 and paint 54 are stored in a refrigerator or freezer, it is also intended that the palette 10 itself without a box 50 may be stored in a refrigerator or freezer 68 as shown in FIG. 8. When the palette 10 itself is placed in the refrigerator or freezer 68, the paint on the palette 10 receives the benefits of slowing the drying of paint described above.

In use, paint daubs 70 are placed on the mixing surface 12 or in the troughs 24 from the paints 54 (FIG. 7). There, the paint may be mixed and then used or used as is as desired by the artist. The artist grasps the palette 10 by placing his or her finger or thumb through the gripping hole 18.

While the above description contains many specificities, these should not be construed as limitations on the scope of the invention, but rather as an exemplification of one preferred embodiment thereof. Many other variations are possible such as additional numbers and locations of troughs 24, grayscale segments 26, color wheels 28 and proportions and dimensions of the palette 10 or box 50, materials of construction, configuration of the box 50 or number or locations of handles 66.

Accordingly, the scope of the invention should be determined not by the embodiments illustrated, but by the appended claims and their legal equivalents. The description contained herein is intended to be illustrative and not exhaustive. Many variations and alternatives of the described technique and method will occur to one of ordinary skill in this art. Variations in form to the component pieces described and shown in the drawings may be made as will occur to those skilled in the art. Further, although certain embodiments of a palette 10 have been described, it is also within the scope of the invention to add other additional components or to remove certain components such as the troughs 24, contact paper 44, grayscale value segment 20 or color wheel 28. All these alternatives and variations are intended to be included within the scope of the attached claims. Those familiar with the art may recognize other equivalents to the specific embodiments described herein which equivalents are also intended to be encompassed by the claims attached hereto. As a result, while the above description contains may specificities, these should not be construed as limitations on the scope of the invention but rather as examples of different embodiments thereof. Accordingly, the scope of the invention should be determined not by the embodiments illustrated but by the appended claims and their legal equivalents.

I claim:

1. A painter's palette comprising a mixing surface having a top side and a bottom side.

2. The painter's palette of claim 1 further comprising at least one trough attached to the mixing surface, each trough having a substantially concave cross-section and having sides, each side having a top and a bottom, the bottoms of the sides meeting at a bottom portion at a lowest portion of the sides, the trough having an opening between the tops of the sides.

3. The painter's palette of claim 2 wherein the at least one trough extends downward lower than the bottom side of the mixing surface.

4. The painter's palette of claim 2 wherein the at least one trough has open ends.

5. The painter's palette of claim 2 wherein the at least one trough has closed ends.

6. The painter's palette of claim 5 wherein the at least one trough has end caps that are dimensioned to fit securely into or onto the ends of the trough to close the ends of the trough.

7. The painter's palette of claim 6 wherein the end caps are permanently attached to or formed with the ends of the trough.

8. The painter's palette of claim 6 wherein the end caps are removably attached to or formed with the ends of the trough.

9. The painter's palette of claim 1 further comprising at least one grayscale segment located on the top side of the mixing surface.

10. The painter's palette of claim 1 further comprising at least one color wheel located on the top side of the mixing surface.

11. The painter's palette of claim 10 further comprising at least one grayscale segment located on the top side of the mixing surface.

12. The painter's palette of claim 1 further comprising contact paper adaptable to overlie the mixing surface and dimensioned to correspond to the dimensions of the mixing surface so that the contact paper covers substantially all of the top side of the mixing surface.

13. The painter's palette of claim 12 wherein the contact paper is a thin, flexible material having a first and a second side, the first side adaptable to come into contact with the top side of the mixing surface, the first side having an adhesive applied to at least a portion thereof so that at least a portion of the first side is sticky whereby the first side is applied to and adheres to the top side of the mixing surface.

14. The painter's palette of claim 12 wherein the contact paper is made of layers of water absorbable material.

15. The painter's palette of claim 12 wherein the contact paper is clear.

16. The painter's palette of claim 12 wherein the contact paper is colored.

17. The painter's palette of claim 12 wherein the contact paper includes a grayscale segment on its second side.

18. The painters palette of claim 12 wherein the contact paper includes a color wheel on its second side.

19. The painter's palette of claim 12 wherein the contact paper comprises several pieces of contact paper stacked upon each other in layers so that after use, the piece of used contact paper may removed thereby exposing a clean piece of contact paper for use.

20. The painter's palette of claim 12 further comprising at least one trough attached to the mixing surface, each trough having a substantially concave cross-section with an inside surface and wherein the contact paper overlies at least the inside surface of each trough.

21. The painter's palette of claim 1 wherein the mixing surface is colored by a color or colors chosen from a group consisting of a medium value or neutral color.

22. The painter's palette of claim 21 wherein the medium value or neutral color is a marbled combination of cool and warm gray.

23. The painter's palette of claim 1 wherein the mixing surface is colored white.

24. The painter's palette of claim 1 wherein the mixing surface has a peripheral edge and a lip extending around at least a portion of the peripheral edge; and further comprising:
a box for storing or transporting the mixing surface, the box comprising
a bottom portion sized to store the mixing surface and having a ledge to support the lip of the mixing surface; and
a top portion, the top portion being sized to mate with the bottom portion to form an integral box, the top portion being sized to allow a space between any paint on the mixing surface stored in the box and the top portion.

25. The painter's palette of claim 24 wherein the bottom portion of the box is sized to store paint brushes and paint in addition to storing the mixing surface.

26. The painter's palette of claim 24 wherein the mixing surface and the box are made of materials that allows the mixing surface and the box to be stored in a freezer or refrigerator.

27. A painter's palette comprising:
a mixing surface having a top side and a bottom side, wherein the mixing surface is colored by a color or colors chosen from a group consisting of a medium value, neutral color or white and wherein the mixing surface has a peripheral edge and a lip extending around at least a portion of the peripheral edge;
at least one trough attached to the mixing surface, each trough having a substantially concave cross-section and having sides, each side having a top and a bottom, the bottoms of the sides meeting at a bottom portion at a lowest portion of the sides, the trough having an opening between the tops of the sides;
at least one grayscale segment located on the top side of the mixing surface;
at least one color wheel located on the top side of the mixing surface;
contact paper adaptable to overlie the mixing surface and dimensioned to correspond to the dimensions of the mixing surface so that the contact paper covers substantially all of the top side of the mixing surface; and
a box for storing or transporting the mixing surface, the box comprising
a bottom portion sized to store the mixing surface and having a ledge to support the lip of the mixing surface; and
a top portion, the top portion being sized to mate with the bottom portion to form an integral box, the top portion being sized to allow a space between any paint on the mixing surface stored in the box and the top portion.
